(19) United States
(12) Patent Application Publication
(10) Pub. No.: US 2015/0257399 A1
(43) Pub. Date: Sep. 17, 2015

(54) Smoker Insert

(71) Applicant: Keith Edward Valiquette, Waynesville, OH (US)

(72) Inventor: Keith Edward Valiquette, Waynesville, OH (US)

(21) Appl. No.: 14/660,374

(22) Filed: Mar. 17, 2015

Related U.S. Application Data
(60) Provisional application No. 61/954,214, filed on Mar. 17, 2014.

(51) Int. Cl. A23B 4/052

(52) U.S. Cl. CPC A23B 4/052

(57) ABSTRACT

A smoker insert for installation into a grill. The smoker insert includes a tray configured to be inserted into a grill, one or more holes disposed within the tray, and a liquid container having a base, a side wall extending from the base, and a reservoir formed by the base and side wall, wherein the tray is positioned adjacent to the tray.

### CROSS REFERENCE TO RELATED APPLICATIONS

This application claims priority to U.S. Provisional Application Ser. No. 61/954,214 filed Mar. 17, 2014.

### TECHNICAL FIELD

The present disclosure relates to a smoker insert designed to adapt a variety of grills into a smoker. In some embodiments, the present disclosure relates to a smoker insert designed to adapt a variety of charcoal kettle grills into a smoker.

### DESCRIPTION OF DRAWINGS

FIG. 1 is a top plan view of an embodiment of a kettle grill smoker insert;

FIG. 2 is a bottom plan view of the kettle grill smoker insert of FIG. 1;

FIG. 3 is a side isometric view of the kettle grill smoker insert of FIG. 1;

FIG. 4 is a side isometric view of a liquid container insertable into the smoker insert of FIG. 1;

FIG. 5 is a top plan view of an embodiment of a kettle grill smoker insert with the liquid container disposed therein positioned within a charcoal kettle grill;

FIG. 6 is a top isometric view of an embodiment of a kettle grill smoker insert placed into a charcoal kettle grill with the hinged grill surface shown; and

FIG. 7 is a side elevational view of the smoker insert of FIG. 1 with the liquid container of FIG. 4 inserted therein.

### DETAILED DESCRIPTION

Certain embodiments shown and described herein provide the ability to convert a grill such as for example, a fossil fuel-fired grill, to a smoker using one or more embodiments of a smoker insert shown and described herein. In some embodiments, the fossil fuel-fired grill could include a wood-fired grill, a charcoal-fired grill, wood pellet-fired grill, any combination thereof, or any other various fossil fuel-fired grills. In some embodiments, the smoker insert permits the conversion of a charcoal grill to a smoker grill without the modification of the existing grill, other than the insertion of the smoker insert into the charcoal grill. Additionally, in some embodiments, the grill can be used for normal grilling without removing the smoker insert. Also, in some embodiments, the smoker insert is adapted to be easily inserted and removed from the grill.

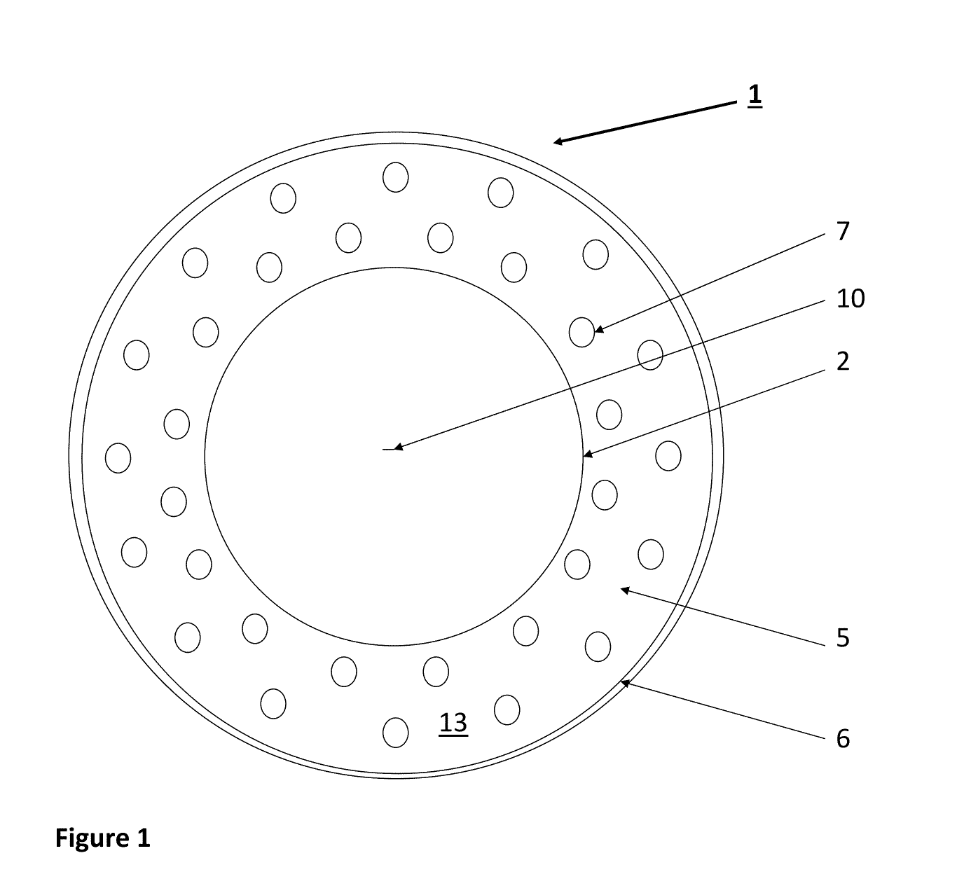

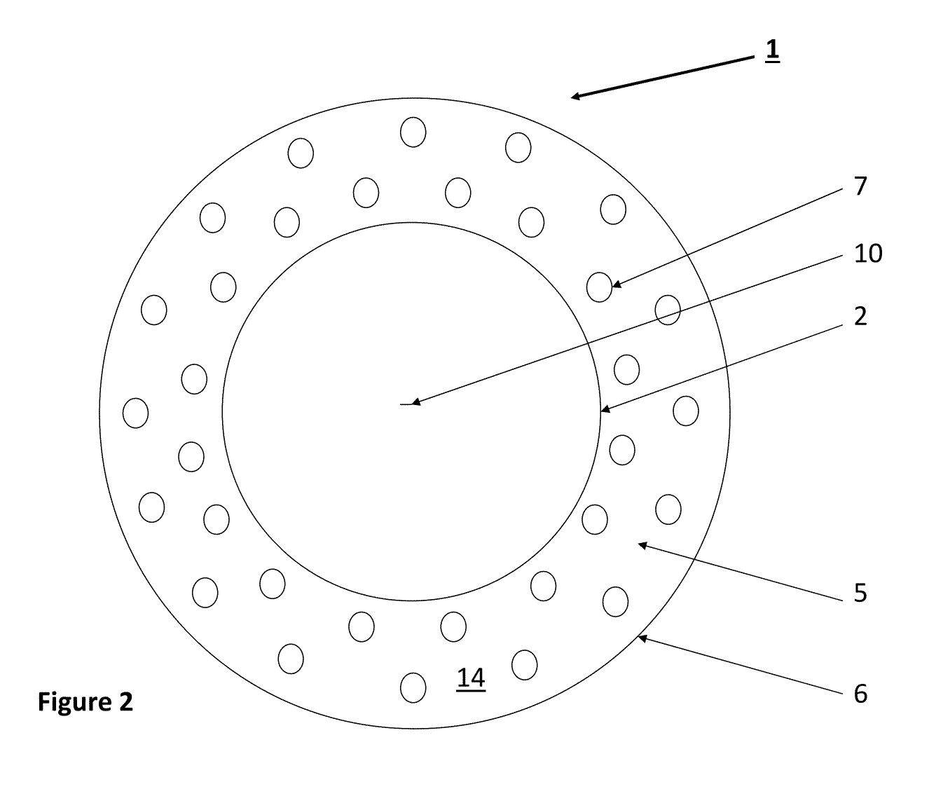

Referring to FIGS. 1-7, an embodiment of a smoker insert (1) is shown. In this embodiment, the smoker insert (1) is adapted to insert into a charcoal kettle grill (30) such as, for example, those conventionally available on the market. In this non-limiting embodiment, the smoker insert (1) is fabricated from any type of heavy gauge stainless steel. In other non-limiting embodiments, the smoker insert (1) may be fabricated from aluminum, steel, composites, combinations thereof, or any material capable of providing any combination of heat resistance, strength, and/or an acceptable life. In one embodiment, the smoker insert (1) is configured to insert within charcoal kettle grills from about 12 inches in diameter to about 30 inches in diameter. However, it is understood that the smoker insert (1) may be designed to fit other charcoal kettle sizes and/or diameters as well. In some embodiments, the smoker insert is adapted to be insertable into grills having at least two different diameters without requiring the kettle grills or the smoker insert to be modified. In some embodiments, the smoker insert may be positioned within a grill and/or removed from the grill without modification of the grill or the smoker insert, and without requiring any tools or mechanical fasteners.

In the embodiment shown, the smoker insert (1) comprises a tray (5) having a first surface (13) and a second surface (14), a first wall (2) extending distally from the first surface (13) and second surface (14), one or more holes (7) disposed through the tray (5), and an aperture (10) that the tray encompasses and/or circumscribes. In some embodiments, the aperture (10) may not be encompassed and/or circumscribed, whether partially or completely, by the tray (5). In the embodiment shown in FIGS. 1-7, the smoker insert (1) further includes a liquid container (3) that is configured to insert within the aperture (10).

A first wall (2) extends distally from the first surface (13) at and/or along an interior edge of the tray (5), forming a cylindrical shape or substantially cylindrical shape. In other words, in this embodiment, the first wall (2) follows along and extends from, at least partially, the peripheral edge of the aperture (10). The first wall (2) may also extend distally from the second surface (14) at and/or along the interior edge of the tray (5), forming a cylindrical shape or substantially cylindrical shape. Similarly, a second wall (6) extends distally from the first surface (13) at and/or along a peripheral edge of the tray (5), forming a cylindrical shape or substantially cylindrical shape. The second wall (6) is coaxial with the first wall (2).

It is understood that the distance the first and second walls extend from the first surface (13) and/or second surface (14) may be the same as each other or different in one or more embodiments. Additionally, the first and second walls may extend only partially or completely about the interior and peripheral edges of the tray (5), respectively. As shown in this embodiment, the first and second walls extend from the first surface (13) at about a 90 degree angle. In addition, the first wall (2) extends from the second surface (14) at about a 90 degree angle. However, it is understood that one or both of these walls may extend at any angle as desired. In some embodiments, one or both of the first and/or second walls may not be included.

In some embodiments, the second wall (6) may extend from the first surface (13) about 2 inches, in another embodiment about 3 inches, in another embodiment about 4 inches, in yet another embodiment about 5 inches, in still yet another embodiment about 6 inches, and/or in still yet another embodiment about 7 inches.

In some embodiments the first wall (2) may extend from the first surface (13) about 1 inch, in another embodiment about 2 inches, in another embodiment about 3 inches, in yet another embodiment about 4 inches, in still yet another embodiment about 5 inches, and/or in still yet another embodiment about 6 inches. In some embodiments, the first wall may be operable to assist in containing and/or supporting the liquid container (3) within the aperture (10), containing and/or holding fuel such as, for example, charcoal or wood, on the tray (5), and/or supporting a charcoal starter chimney. In some embodiments the first wall (2) may extend from the second surface (14) of about 1 inch, in another embodiment at least about 2 inches, in another embodiment at least about 3 inches, in yet another embodiment at least about 4 inches, in still yet another embodiment at least about 5 inches, and/or in still yet another embodiment at least about 6 inches. In some embodiments, the tray (5) may rotate within and relative to the grill. In some embodiments, the tray (5), first wall (2), and/or the second wall (6) may be designed or configured to contain and/or hold a fuel such as, for example, fossil fuels, including but not limited to wood, charcoal, or the like.

The one or more holes (7) disposed in and through the tray (5) may be uniformly or randomly disposed about the tray. The hole (7) may have any size, shape, and/or configuration. In some embodiments, the holes (7) may be configured and/or sized to not permit the fuel to pass therethrough, yet permit ash to pass through the one or more holes (7) and thus pass through the tray (5). In these same or other embodiments, the one or more holes (7) may be configured to provide oxygen and/or air flow for combustion. In some embodiments, the one or more holes (7) may comprise about 35 cylindrical holes of various dimensions, in another embodiment about 30 cylindrical holes, in another embodiment about 25 cylindrical holes, in yet another embodiment about 20 cylindrical holes, in still yet another embodiment about 15 cylindrical holes, and/or in still yet another embodiment about 10 cylindrical holes.

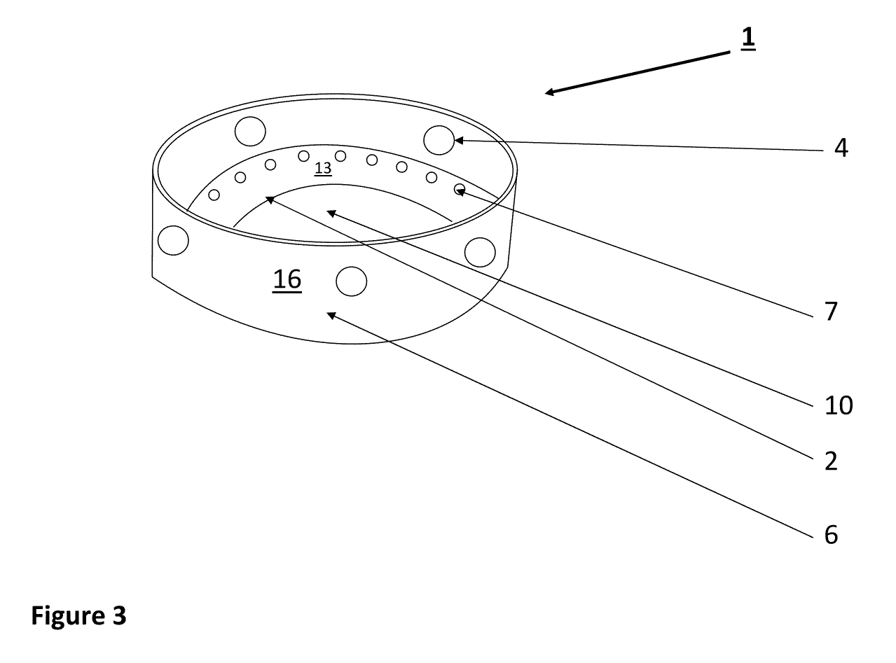

As shown in FIG. 3, the second wall (6) includes one or more holes (4) disposed in and along a surface (16) of this wall. Moreover, although this embodiment shows a round hole (4), the hole (4) may have other shapes, sizes, and/or configurations such as a cylinder, oval, square, or polygon. In some embodiments, the one or more holes (4) may be about 1 inch in diameter, in another embodiment about 2 inches, in another embodiment about 3 inches, in yet another embodiment about 4 inches, in still yet another embodiment about 5 inches, and/or in still yet another embodiment about 6 inches as shown in FIG. 3. The one or more holes (4) may be dispersed on only one side of the smoker insert or dispersed completely around the smoker insert in either a random or uniform configuration.

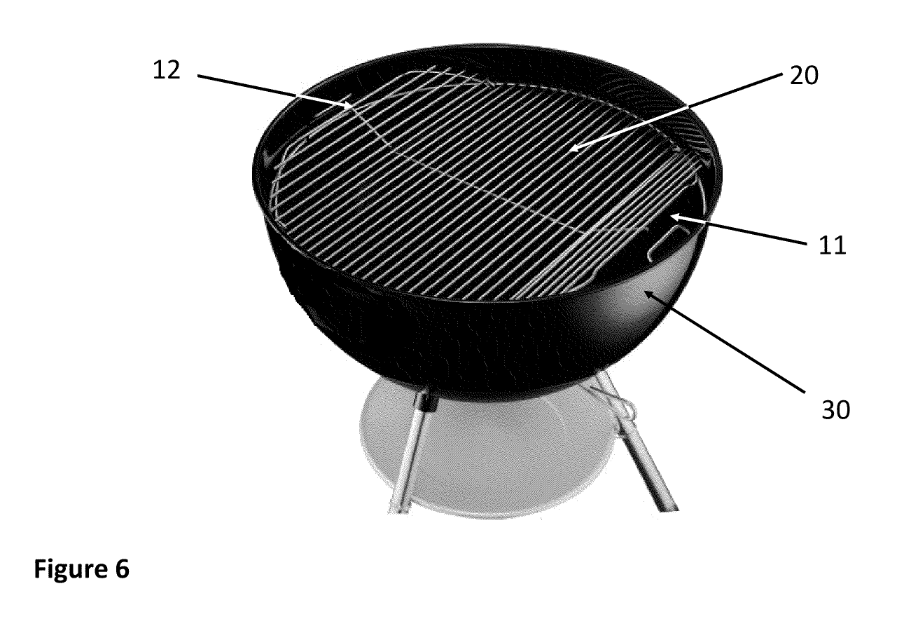

The holes (4) along the perimeter of the tray allow various cooking utensils to be used to assist in causing the tray (5) to pivot and/or rotate across the existing charcoal grate in a +/−360 degree pattern within the grill which may allow charcoal to be added and redistributed to and/or around the tray during the smoking process to maintain the desired temperature and provide even heat throughout the smoker grill. As one example, a hinged grill surface (20) on an illustrative grill 30 shown in FIG. 6 allows fuel such as, for example, charcoal, to be added through an access point (11) or an access point (12) during the smoking process. In some embodiments, the holes (4) may be replaced with other mechanisms that will enable the tray (5) to pivot or rotate on the first wall (2) which extends from the second surface (14).

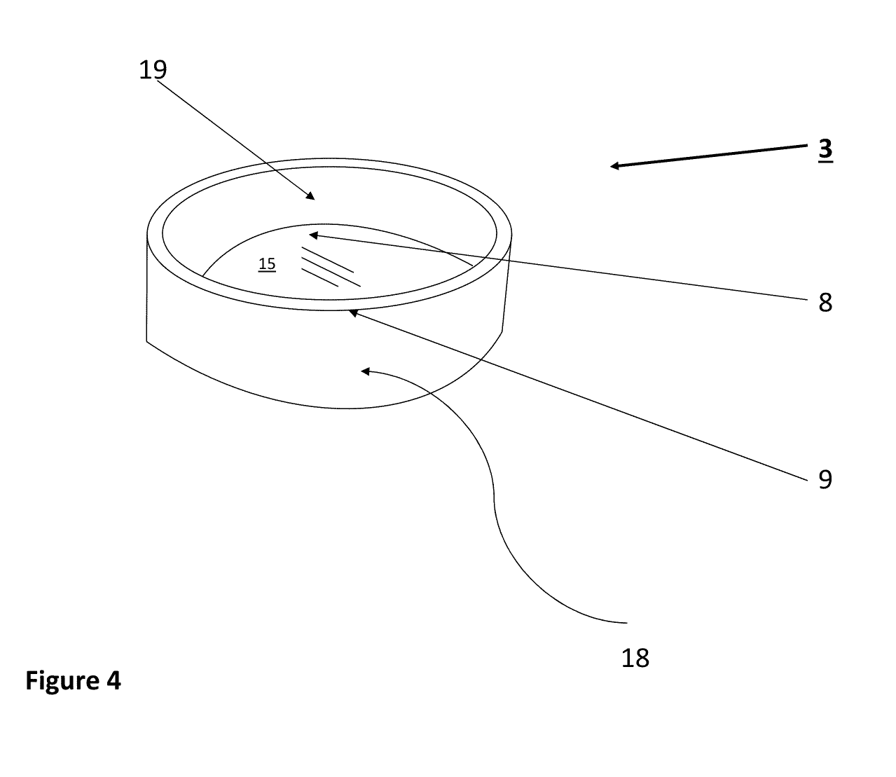

Referring to FIG. 4, the liquid container (3) is shown separated from the tray (5). In this embodiment, the liquid container (3) is a separate and distinct component from the tray (5); however, it is understood that liquid container (3) could be an integral to the tray. In the illustrative embodiment shown, the liquid container includes a base (8), a side wall (18) extending distally from the peripheral edge of the base, and a reservoir (19) formed within base and side wall. The side wall (18) extends from an interior surface (15) of the base (8) at about a 90 degree angle and at any desired length to a top (9) of the side wall. In some embodiments, the side wall (18) extends from the base at about 2 inches, in another embodiment about 3 inches, in another embodiment about 4 inches, in yet another embodiment about 5 inches, in still yet another embodiment about 6 inches, and/or in still yet another embodiment about 7 inches. In some embodiments, the side wall may extend from the base at various other angles and lengths.

The liquid container (3) may be fabricated from any type of heavy gauge stainless steel. In other non-limiting embodiments, the liquid container (3) may be fabricated from aluminum, steel, composites, combinations thereof, or any material capable of providing a combination of heat resistance, strength, and long life. As shown in this illustrative embodiment, the liquid container is fabricated as one integral component. In some embodiments, the liquid container is fabricated such that the reservoir (19) is operable to contain and/or hold a liquid such as, for example, water, therein. As shown, the liquid container (3) does not include an upper wall (or the top (9) is open) to permit liquid to be dispersed into the reservoir (19). In some embodiments, the liquid container could include a partial or complete upper wall, and thus have a liquid inlet in communication with the reservoir therein. In other words, the liquid container could be a partially or completely enclosed container having a liquid inlet connected to the reservoir and disposed through the base, side wall, or upper wall to permit liquid to be dispersed into and/or out of the reservoir.

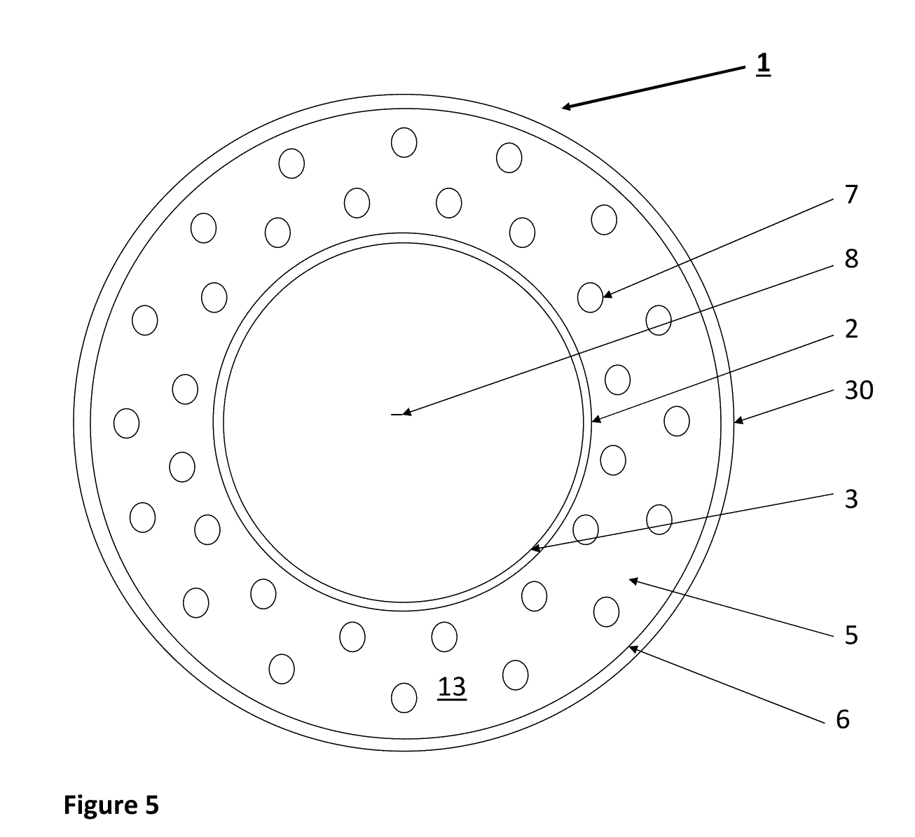

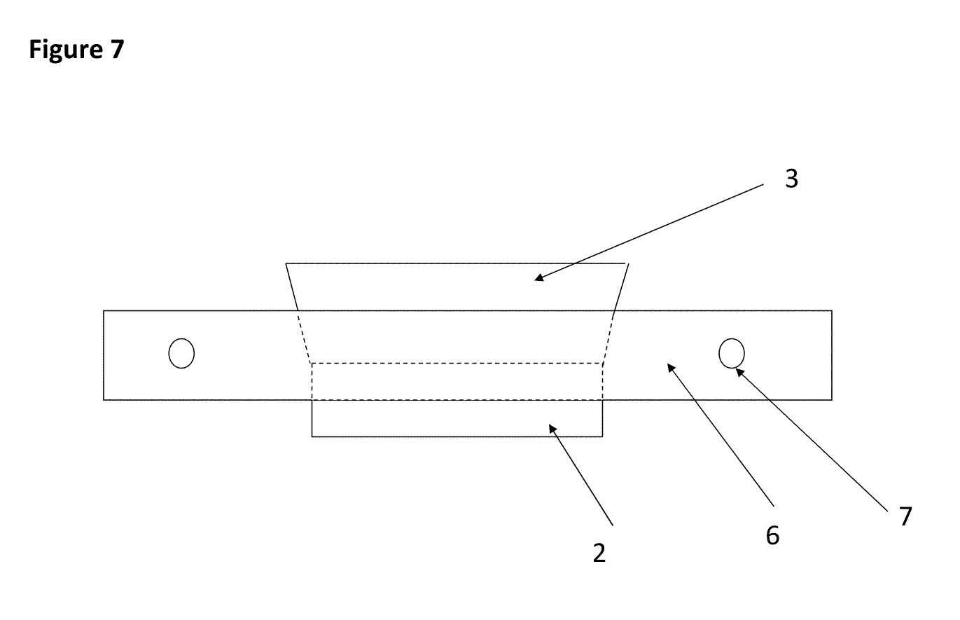

Referring to FIGS. 5 and 7, the liquid container (3) is disposed within the aperture (10) and thus within the first wall (2) of the tray (5). In this embodiment, the tray and liquid container are configured such that the liquid container is removable while the tray is in the grill or outside of the grill. As set forth above, the first wall (2) may extend a distance from the second surface (14). In some embodiments, the first wall (2) is extended a sufficient length or distance from second surface (14) to provide sufficient space for a portion of the liquid container (3) to extend below the first surface (13) of the tray (5). In such embodiments, the second side wall (2), which is below the second surface (14), and the base (8) are resting upon the charcoal grate of the grill.

In some embodiments, a smoker insert (1) may be configured to install into a number of charcoal kettle grills having an overall diameter that may range from about 12 inches in diameter to about 30 inches in diameter from various manufacturers.

In one or more of the embodiments shown and/or described above herein, a smoker insert positioned within any variety of grills. In one example, the smoker insert may be positioned upon a charcoal grate or other fossil fuel grate within a kettle grill of various diameters without requiring any physical modification to the grill construction. Thus, a retrofit of a current grill, for example, a charcoal kettle grill, to a smoker, and/or back to the grill, for example, the charcoal kettle grill, without having to modify the grill construction except for the insertion and removal of the smoker insert into and from the grill. Although the smoker insert is shown having a circular and/or cylindrical shape in the embodiments shown herein, it is understood that any other shape and/or configuration is feasible and contemplated such as, for example, square, rectangular, oval, or the like. As an example, one or more embodiments of the smoker insert shown and/or described above herein may be used to convert or retrofit a gas grill such as, for example, a natural gas or propane gas grill.

As an example, typical charcoal starting procedures includes igniting the charcoal for smoking. In some embodiment, the first wall (2) has a raised surface to provide a place for a charcoal chimney starter to rest during the ignition of the charcoal. It also is designed as a resting spot for the liquid container during the smoking process. When the charcoal has ignited, it is poured into the tray (5). The charcoal rests in the tray around the perimeter of the kettle grill smoker insert with the holes (7) positioned about the tray to, optionally, allow ashes to drop to the bottom of the grill while, optionally, allowing adequate oxygen for combustion.

In some embodiments, a kit may include the tray (5), the liquid container (3) and/or any one or more of the other features shown and/or described herein.

In some embodiments, a method of converting an existing grill into a smoker includes removing a grilling surface of a grill; inserting the smoker insert into the grill; positioning the smoker insert onto an internal surface of the grill such as, for example, a charcoal grate; inserting the liquid container onto the tray or into the aperture of the tray; and/or inserting the grilling surface back into the grill. The method may include one or more of the steps, any combination of such steps, and/or any order of such steps. In some embodiments, the method of converting an existing grill consists of removing a grilling surface of a grill; inserting the smoker insert into the grill; positioning the smoker insert onto an internal surface of the grill such as, for example, a charcoal grate; inserting the liquid container onto the tray or into the aperture of the tray; and/or inserting the grilling surface back into the grill.

What is claimed is:

1. A smoker insert comprising:
a tray configured to be inserted into a grill;
one or more holes disposed within the tray; and
a liquid container having a base, a side wall extending from the base, and a reservoir formed by the base and side wall, wherein the tray is positioned adjacent to the tray.

2. The smoker insert of claim 1, further comprising an aperture disposed within the tray and operable to receive the liquid container therein.

3. The smoker insert of claim 2, further comprising a first wall extending distally from a first surface of the tray and along a peripheral edge of the aperture.

4. The smoker insert of claim 3, further comprising a second wall extending distally from the first surface and along a peripheral edge of the tray.

5. The smoker insert of claim 4, wherein the aperture, first wall and second wall are coaxial, and the second wall circumscribes the first wall.

6. The smoker insert of claim 2, wherein the first wall also extends distally from a second surface of the tray and along the peripheral edge of the aperture.

7. The smoker insert of claim 4, further comprising one or more holes disposed within the second wall.

8. The smoker insert of claim 1, further comprising a first wall extending distally from a first surface and an interior edge of the tray.

9. The smoker insert of claim 8, further comprising a second wall extending distally from the first surface and along a peripheral edge of the tray.

10. The smoker insert of claim 1, further comprising a second wall extending distally from a first surface and along a peripheral edge of the tray.

11. The smoker insert of claim 1, wherein the smoker insert is adapted to be insertable into grills having at least two different diameters without requiring the kettle grills or the smoker insert to be modified.

12. The smoker insert of claim 1, wherein the smoker insert may be positioned within a grill and removed from the grill without modification of the grill or the smoker insert, and without requiring any tools or mechanical fasteners.

13. The smoker insert of claim 1, wherein the smoker insert is insertable into grills of various manufacturers and sizes.

14. The smoker insert of claim 13, wherein the grills are charcoal kettle grills.

15. The smoker insert of claim 1, wherein the tray rotates within and relative to the grill.

16. The smoker insert of claim 1, wherein the liquid container is fixedly connected to the tray.

17. A kettle grill smoker insert comprising:
a tray having an aperture disposed therein, the tray adapted to fit within a kettle grill;
a first wall extending from a peripheral edge of the aperture;
a plurality of holes disposed in and about the tray; and
a liquid container disposed within the aperture.

18. The kettle grill smoker insert of claim 17, further comprising a second wall extending from a peripheral edge of the tray and coaxial with the first wall.

19. The kettle grill smoker insert of claim 17, wherein the smoker insert is adapted to insert and rest within any kettle grill ranging in diameter from about 12 inches to about 30 inches.

20. A method of converting an existing grill into a smoker comprising:
inserting the smoker insert into the grill;
positioning the smoker insert onto an internal surface of the grill; and
inserting the liquid container adjacent the tray.
